(19) United States
(12) Patent Application Publication
(10) Pub. No.: US 2011/0212422 A1
(43) Pub. Date: Sep. 1, 2011

(54) Cognitive Capacity Assessment System

(75) Inventors: Robert D. O'Donnell, Dayton, OH (US); Samuel L. Moise, JR., Meadow Vista, CA (US); Douglas R. Eddy, Hillsboro, OR (US)

(73) Assignee: NTI, INC., Fairborn, OH (US)

(21) Appl. No.: 13/035,757

(22) Filed: Feb. 25, 2011

Related U.S. Application Data
(60) Provisional application No. 61/308,755, filed on Feb. 26, 2010.

(51) Int. Cl. G09B 19/00

(52) U.S. Cl. 434/236

(57) ABSTRACT

Systems and methods for cognitive assessment are provided that test a subject's cognitive capacity using a battery of tests that are selected with respect to a specific job that the subject is expected to perform. The test results are analyzed based upon the relative criticality of each cognitive ability that is required by the job to provide an overall assessment of the subject's cognitive capacity to perform the job. Predictions about the subject's future capacity to perform the job can also be made by analysis of expected workload and recovery schedules.

### RELATED APPLICATION

The present application claims priority to U.S. provisional patent application Ser. No. 61/308,755 filed 26 Feb. 2010, which is incorporated herein by reference in its entirety.

### BACKGROUND

1. Field of the Invention

The present invention is generally directed toward cognitive capacity assessment and is more particularly related to assessing, evaluating and predicting the impact of workload on a person's cognitive capacity to perform a specific job, mission, task or activity.

2. Related Art

The goal of conventional laboratory performance testing is to yield information that is of use in the real world outside the laboratory. This is especially true in aerospace and military contexts, where the purpose of the laboratory testing is usually to enhance performance, detect degraded performance, or improve selection. Such research has provided an enormous amount of information that not only gives insight into human capabilities, but also yields specific recommendations concerning optimization of those capabilities. Yet, there has always been something of a gap between the laboratory and the real world users of the information, whether that user is focused on military, medical, industrial, or educational applications. Simply put, the real world users frequently find it difficult to relate laboratory tasks to actual real world jobs.

An obvious solution to this problem of bridging the gap between the laboratory and the real world is to conduct actual field experiments in the environment of interest. When this can be done, it is certainly a desirable way to go (although not without its own problems). However, such experiments can be extremely costly and complex, and can only be done in limited contexts. Short of such actual field studies, high-fidelity simulations provide the next level of credibility. The validity of that approach, as well as the ability to present task interactions in all of their complexity, can lead to much easier acceptance by the real world user. Again, however, such simulations are very costly, and only a limited number can be carried out. Further, there is some concern that the very fidelity of the simulation may restrict the range of environments to which the results can be generalized. In other words, as the fidelity of the simulation increases, and as it comes to look more and more like a real world environment or task, it may be less and less applicable to other, even similar, tasks or environments.

Many believe that the most cost efficient and generalizable approach is to use so-called “synthetic” laboratory performance tasks that attempt to probe basic skills assumed to be required by the actual jobs of interest. Although the validity of this belief rests on the assumption that the tasks do in fact probe job skills, many such performance tests have been created, each attempted to measure primarily one or more dimensions of human ability. Further, tests have been assembled into ‘batteries’ that attempt to measure a range of abilities. These have proven to be valid in many situations and, with few exceptions, they likely do probe skills that are necessary in many jobs. However, application of these test batteries to any specific job or task suffers because such application remains a laboratory exercise. For example, the researcher must make assumptions about what the tests in the battery actually measure and these assumptions are typically uni-dimensional in that each test is thought to measure one major skill or aspect of human performance. In other words, a test (e.g., tracking) is assumed to measure a specific skill (e.g., visual-motor control), even though it is apparent that performance on even a simple tracking test is dependent to varying degrees on several other skills or cognitive attributes (e.g., sustained attention, working memory, directed attention, etc.). Further, in most cases the assumptions underlying selection of a particular test from a battery are not spelled out and, even if these assumptions are correct, the real world user has no way to interpret the results in any practical way because there is no audit trail describing why a particular test is appropriate in a given application. The unfortunate result is that laboratory results on synthetic tasks remain difficult to apply to a real world job or mission and are therefore either ignored or misinterpreted and used in inappropriate ways by the real world user. Therefore, what is needed is a system and method that overcomes these significant problems found in conventional laboratory performance testing as described above.

### SUMMARY

Accordingly, described herein is a system and method for performance testing and cognitive capacity assessment of human subjects. As a basic foundation for cognitive capacity assessment, the present inventors developed a comprehensive taxonomy of human cognitive skills. This taxonomy includes those human cognitive skills that can be identified and are reasonably independent or orthogonal to each other. Each cognitive skill in the taxonomy is separately described in a way that permits the cognitive skill to be correlated with the demands of a job, mission, task, or activity (herein referred to collectively as “job”). This taxonomy was developed by the inventors and a description of its development, and the taxonomy itself was published in Aviation, Space, and Environmental Medicine Journal (July, 2006), which is incorporated herein by reference in its entirety. The taxonomy is unique in that it represents a substantially complete list of cognitive skills needed to perform a job.

In combination with the taxonomy, certain tests that probe the various cognitive skills identified in the taxonomy were identified and generated. These tests carry out the “assessment” function and the inventors developed and implemented an “armory” of such tests including a plurality of different procedures and relative variations. The armory concept involves developing many tests, from which specific combinations are to be selected for specific applications. The armory approach advantageously allows for cognitive assessment to be applied to specific jobs. A description of the development of the armory and the list of tests is included in the previously described published article.

For the tests in the armory to facilitate effective assessment of cognitive capacity, the tests in the armory need to be related to the cognitive skills identified in the taxonomy described above. To do this, the tests are described in the same cognitive terms as the taxonomy. Accordingly, for each test in the armory it was determined what cognitive skills from the taxonomy were probed, and the degree to which each cognitive skill was critical to successful performance on the test. This produced a one-dimensional mathematical vector describing the cognitive demands of the test.

To further relate the tests to the armory, a two dimensional matrix of the cognitive skills identified in the taxonomy in one dimension and the cognitive tests in the armory in the other dimension was developed. This matrix (“T-Matrix”) provides an ordinally-scaled vector for each test in the armory. Advantageously, the use of completely different elements (tests and cognitive skills) as the dimensions of the T-Matrix and the use of an ordinal approach permits a more robust algebraic treatment of the resulting data not provided by conventional laboratory testing systems.

In accordance with the T-Matrix, a subset of tests from the armory (“cognitive test batteries”) that are particularly appropriate to the cognitive demands of specific jobs is used in order to assess the cognitive capacity of a person for a particular job. Accordingly, the cognitive demands of a job are determined, e.g., through evaluation of job task analyses, training manuals, interviews with subject-matter-experts (“SMEs”) and the like and the cognitive skills in the taxonomy are ordinally rated, based on whether they are required for successfully carrying out the job. The ordinal rating involves a numerical assignment of how critical each cognitive skill is to the specific job or task. Because these ordinal ratings may not truly reflect the non-linear nature of the demand-criticality relationship, further mathematical treatments can be applied to convert whatever scale is obtained into an appropriate non-linear quantification. These non-linear transformations may involve such approaches as cusp theory, chaos theory, fuzzy logic, or others. In any case, this creates a vector describing the job's cognitive demands in the same terms as those used in the T-Matrix. In effect, it creates a marginal row in the T-Matrix that identifies the “quantified” cognitive skills that should be tested by a battery.

The next step in generating a cognitive test battery is to select the minimum number of tests that optimally probe the job's cognitive demands. This is done by using an optimization algorithm, for example a simple additive model can be used. However, other optimization algorithm approaches may also be used. The result is a quantified estimate of how well each test in the armory probes the cognitive skills demanded by the particular job. The resulting tests are then sorted from most to least effective in assessing the cognitive demands of the job. Accordingly, in practice a certain number of tests that are appropriate to the testing situation's limits (e.g., time or subject constraints) can be selected for use to assess the subject's cognitive capacity for the particular job.

Once the battery of tests is identified, the tests are administered to the subject. The results of the tests are quantified and analyzed with respect to the criticality of the cognitive demands for the job. Predictions about future capacity can also be made based on information regarding expected workload and recovery over time.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a flow diagram illustrating an example process for creating cognitive test batteries applicable to the evaluation of specific jobs, task, missions, or systems according to an embodiment of the present invention;

FIG. 2 is a table diagram illustrating an example list of cognitive skills according to an embodiment of the present invention;

FIG. 3 is a table diagram illustrating an example list of test procedures for probing cognitive skills according to an embodiment of the present invention;

FIG. 4 is a table diagram illustrating an example T-Matrix of cognitive skills and tests according to an embodiment of the present invention;

FIG. 5 is a graph diagram illustrating an example output of test results for a test battery according to an embodiment of the present invention;

FIG. 6A is a network diagram illustrating an example system for cognitive capacity assessment according to an embodiment of the present invention;

FIG. 6B is a block diagram illustrating an example cognitive capacity assessment server according to an embodiment of the present invention;

FIG. 6C is a flow diagram illustrating an example process for predicting performance according to an embodiment of the present invention;

FIG. 7 is a block diagram illustrating an example wireless communication device that may be used in connection with various embodiments described herein; and

FIG. 8 is a block diagram illustrating an example computer system that may be used in connection with various embodiments described herein.

### DETAILED DESCRIPTION

Certain embodiments disclosed herein provide systems and methods for cognitive capacity assessment. For example, one method disclosed herein allows for the creation of a matrix of cognitive skills and tests that is used to determine the cognitive capacity of a subject to perform a particular job or task that requires certain cognitive skills. After reading this description it will become apparent to one skilled in the art how to implement the invention in various alternative embodiments and alternative applications. However, although the primary embodiment of the present invention set forth herein is described in the context of a testing and evaluation system, it should be understood that this embodiment is presented by way of example only, and not limitation. As such, this detailed description of various alternative embodiments should not be construed to limit the scope or breadth of the present invention.

Integrating Cognitive Assessment into the Test and Evaluation Process

There is a paradigm shift occurring in the cognitive performance assessment areas of operational test and evaluation. From the vantage point of the 21st century, there is an increasing realization that human cognition in complex, technological environments is an extremely plastic entity. The human is capable of interacting with the system by employing a variety of cognitive skills in a variety of combinations. While a system may be designed to be operated on by the human in a particular way, and the system may be tested based on that design, the person frequently finds ways to operate within the system that utilize a significantly different mix of cognitive skills than anticipated. The ingenuity and flexibility demonstrated by the Apollo 13 crew, for example, would have been difficult to anticipate in any evaluation of the system.

Human engineering typically is directed to optimizing person-system interaction, and in that, it has been eminently successful. However, it is becoming clear that there is a need to move beyond those optimal conditions in order to anticipate and evaluate the person's ability to function in degraded system environments. The problem, of course, is that introducing human flexibility into the testing equation makes it impossibly complex. It is difficult enough to design tests of a system where it is assumed that the human is optimally trained and functioning. If one now adds the complexity of potential human cognitive adaptations to the situation, the problem of designing adequate evaluations becomes formidable.

One solution to this problem described herein is to abandon the attempt to probe every possible approach the human may take in operating a system, and rather to concentrate on the skills necessary for successful performance under any reasonable range of system conditions. Accordingly, those cognitive (and psychomotor) skills the person must have in order to successfully operate the system under any expected conditions are determined in order to allow the measured cognitive capacity to be matched to the various system demands.

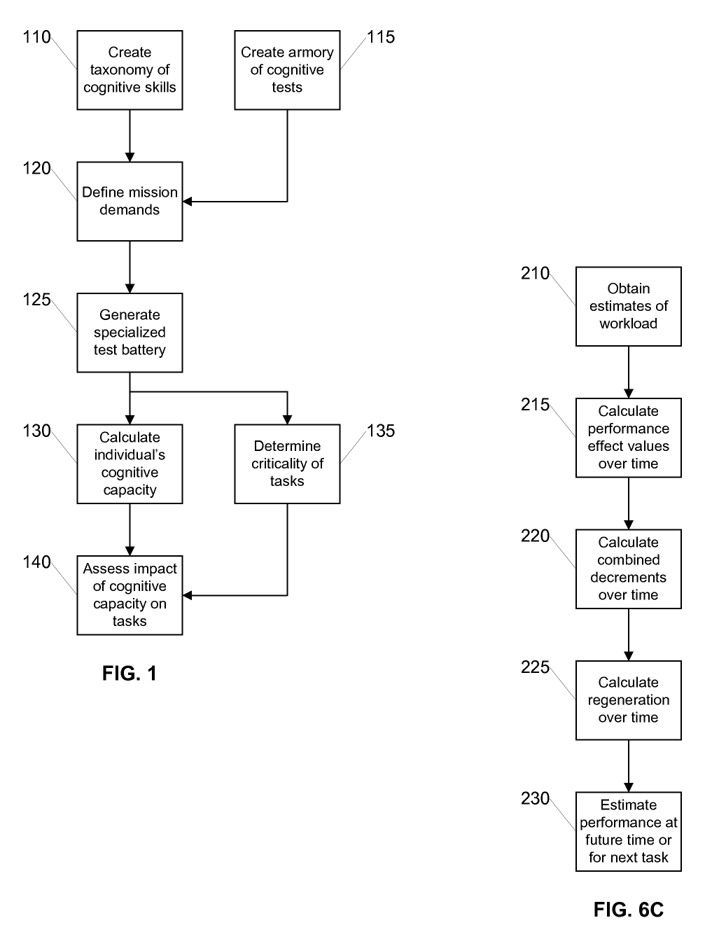

FIG. 1 is a flow diagram illustrating an example process for creating cognitive test batteries applicable to the evaluation of specific jobs, tasks, missions, or systems according to an embodiment of the present invention. In one embodiment, the illustrated process may be implemented by the system later described with respect to FIGS. 6A and 6B. Initially, in steps 110 and 115 a taxonomy of cognitive skills and an armory of cognitive tests are created. As shown, these steps may be performed separately. If the taxonomy and armory are already created, then in steps 110 and 115 respectively these data are obtained, e.g., from a data storage area or memory. In step 120, the demands of the job are defined. The job can be a singular task or may comprise a plurality of singular tasks. In step 125 a specialized battery of tests is generated that is specific to the job. The test battery preferably includes a comprehensive set of tests that collectively cover each of the cognitive skills that are involved in the job.

In step 130 the tests are given to an individual to determine the person's cognitive capacity and separately in step 135 the criticality of each of the various tasks that are part of the job is determined. Step 135 may be performed before or after testing of a person. Finally, in step 140 the impact of the person's cognitive capacity on the tasks is assessed to facilitate an overall evaluation of the job. Below, each of these steps will be discussed in further detail.

### Overall Concept

The systems and methods described herein provide a cognitive assessment system that can be directly tailored to relate to any specific job. Initially, the minimum set and level of cognitive capacities are determined that allow a person to successfully carry out a particular task or operate a given system in the context of a certain job and/or system condition.

Advantageously, conventional testing environments have formed the basis for evaluating system-human interaction and creating cognitive test batteries, for example in the areas related to human engineering dating back to early electro-mechanical devices designed primarily for the space program to more modern sophisticated hand-held batteries evolving from programs to assess effects of nerve agents, flight stresses, neurological insult, and other stressors (UTCPAB, CTS, NATO STRESS, ANAM). In these cognitive test batteries a fixed set of tests, usually administered in a fixed order, are employed to assess a range of cognitive capacities. The cognitive capacities are typically defined rather broadly—e.g., mathematical functions, spatial functions, short- and long-term memory processes, etc. In some cases, a theoretical orientation dictates the cognitive capacities tested, such as in testing working memory, declarative memory, and episodic memory. On the testing side, each procedure is assumed to primarily probe one type of cognitive skill.

While there is as yet no “grand unified theory” of cognition, experimental and theoretical developments have led to the point where reasonably comprehensive and well-defined taxonomies of human cognitive capacities can be defined. These well-defined taxonomies led the present inventors to realize that what is actually measured by common test procedures is more complex than the simple uni-dimensional view that had typically been assumed in conventional systems. In fact, it is now clear to the present inventors that any test procedure is dependent on a number of cognitive capacities for successful performance.

The path to greater specification and quantification of cognitive testing therefore became clear to the present inventors. Accordingly, tests probing the entire defined range of human cognitive capacities were identified in terms of the degree to which they actually probed each capacity to establish the foundation for relating those tests to the cognitive demands of a job. Actual implementation of this path envisioned by the inventors required several individual developments that are each discussed below.

Development of Taxonomy of Cognitive Skills

In order to develop a testing system that will be appropriate for a wide range of operational systems and missions, the first step is to define the range of cognitive capacities that will need to be tested. Accordingly, the present inventors developed such a taxonomy that reflects the diverse approaches to cognitive theory and assimilates them into a framework that yields clues regarding how cognitive skill can be probed in a comprehensive way.

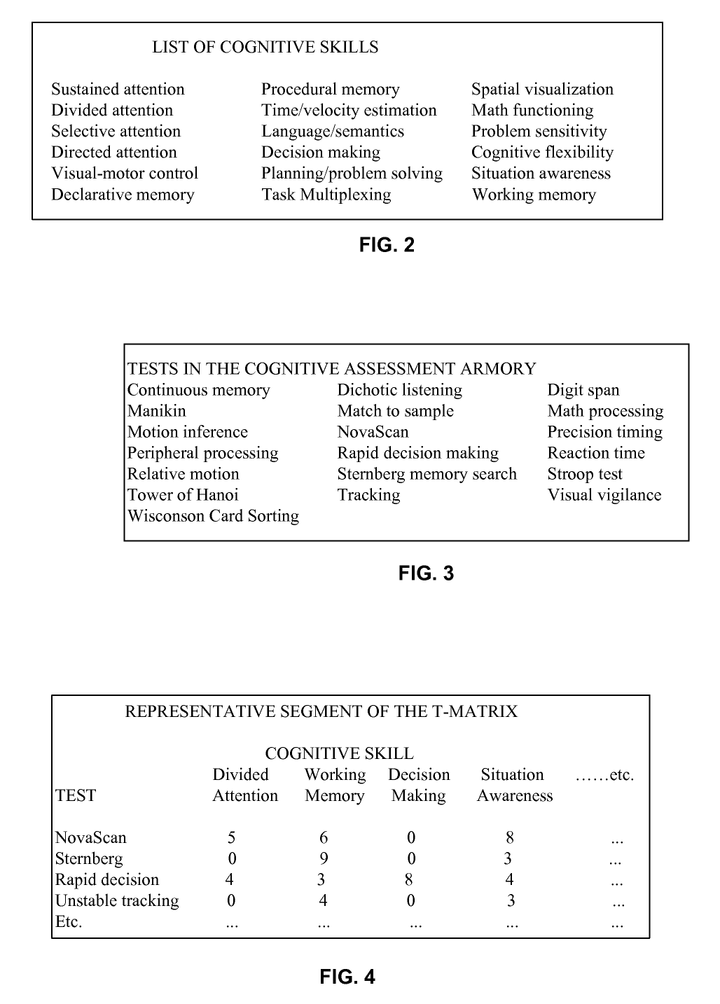

FIG. 2 illustrates a list of the resulting cognitive skills that was constructed through development of the taxonomy. One advantage of the taxonomy is that the selected categories can be related to actual activities required in performing jobs. Accordingly, both “pure” cognitive processes that might be studied in the laboratory and more complex cognitive capacities that might involve several basic cognitive capacities are included. For example, while “situation awareness” may involve elements of both attention and working memory among other cognitive capacities, from a functional point of view, it is an identifiable cognitive process that is important to many jobs.

Creation of a Test Armory

In considering the tests that should be available for a general assessment system, it was desirable to avoid the traditional approach of having a fixed battery designed to be given in the same order every time. Doing so allows the assessments to be tailored to a wide range of applications. The test armory concept was therefore adopted. The test armory includes a large number of tests that generally cover all of the cognitive skills described in the taxonomy and therefore allows a testing situation to generate specific batteries that are tailored to the cognitive demands of a given job.

Accordingly, the test armory provides a sufficiently large number of tests to probe various cognitive skills. FIG. 3 illustrates a list of the tests in the cognitive assessment armory. Advantageously, variations of the tests may increase the total number of test procedures available in the armory. For example, the 19 test procedures listed in FIG. 3 may result in a total of 24 tests with certain variations of some of the 19 tests that are listed. The tests include traditional techniques (e.g., reaction time, mathematical functioning, Sternberg memory search, etc.) as well as new techniques designed to probe more complex functions (e.g., rapid decision making, motion inference, directed attention, etc.).

Selecting a Test Battery for Specific Applications

The existence of a taxonomy and series of tests is only the beginning of actually finding ways to generate specific batteries for specific jobs. It is also necessary to develop a technique for matching the tests to the demands of the job. Advantageously, the objective and quantified way of doing this developed by the present inventors provides an “audit trail” for assessing the relevance of the battery to the job and also lays the foundation for modeling and prediction of human cognitive capacities within the system. As noted above, it was recognized by the inventors that no performance test is dependent on a single cognitive skill identified in the taxonomy. For instance, although a simple reaction time test is certainly dependent on visual-motor coordination, it also requires some degree of attention allocation, sustained attention, focused attention, and other skills. Furthermore, although each skill is individually important, the separate skills are not all equally critical to successful performance on the reaction time test. Advantageously, the inventors have recognized that the estimate of the degree to which each skill is probed by a particular test lays the foundation for relating tests to job demands in a more precise way.

Accordingly, a T-Matrix is constructed in which the cognitive attributes described in the taxonomy (e.g., spatial visualization, working memory, etc) constitute one dimension, and the tests in the armory (e.g., continuous memory, manikin test, etc.) constitute the other. FIG. 4 is a table diagram illustrating an example T-Matrix of cognitive skills and tests according to an embodiment of the present invention.

Using information from cognitive scientists about whether a test does or does not require a given attribute for successful performance, a numerical representation (e.g., on a scale from 0 to 9) to which the test was dependent on that attribute for successful performance can be incorporated into the T-Matrix. As can be seen from FIG. 4, the matrix of values provides an n-dimensional mathematical vector for each test in the armory that specifies, at least on an ordinal scale, the array of cognitive skills that are probed by each test in the armory. These vectors advantageously provide a cognitive map of each test. For example, in FIG. 4, it can be seen that the Sternberg test probes working memory and situational awareness, two major skills. The rapid decision making test, on the other hand, samples a variety of cognitive skills to different degrees. It is also noted that each cognitive skill is sampled by more than one test in the armory, opening up the opportunity for multi-dimensional analysis of each skill.

The T-Matrix advantageously allows selection of a set of cognitive tests that optimally probe the cognitive demands of a particular job. In one embodiment, this is a two-step process. In the first step, the job must be decomposed into its component tasks. For example, if the job is the re-entry and landing of the space shuttle, the starting point of the analysis is an investigation of the individual tasks involved in that mission. Current data on those tasks is obtained from existing task analyses, training manuals, or interviews with subject-matter-experts (“SMEs”). The product of this step is a list of essential tasks that the individual must perform to carry out the mission. These tasks are phrased strictly in terms of actions (e.g., enter data, roll wings level, initiate remote hand controller inputs, etc.), without regard to the cognitive skills required by those actions.

Once the essential tasks are identified, the second step translates those actions into the cognitive skills demanded. This involves an analysis of each category of action identified. The descriptions of cognitive skills in the above described taxonomy are used to identify those that are required for each task category. For instance, the category ‘monitor’ clearly involves considerable working memory, sustained attention, situation awareness, and others. However, it probably does not involve a great deal of visual-motor control, problem solving, or cognitive flexibility.

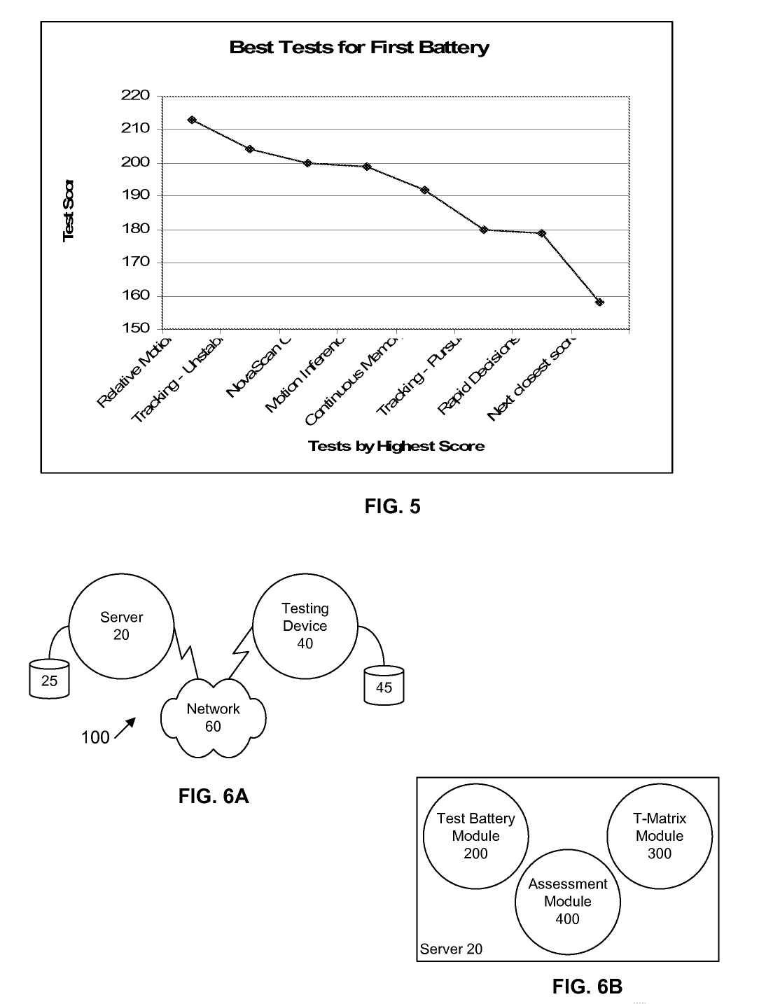

These two sets of data provide the information necessary for the T-Matrix to select the optimum set of tests that best assess the cognitive requirements of the job. This can be carried out automatically through use of a simple optimization algorithm, the output of which presents a prioritized list of tests from the armory. An example of such an output for the re-entry and landing activity of the space shuttle is presented in FIG. 5, which illustrates the relative power for each test from the armory in probing the cognitive demands of the re-entry and landing activity of the space shuttle. The list gives a quantified estimate of how well each test probes the demands of that specific mission, allowing the investigator to select the appropriate number and type of tests based on the unique testing requirements (e.g., time available, subject characteristics, environment, etc.). In one embodiment, after the cognitive demands of the activity are entered, the system automatically identifies the tests for the cognitive assessment and optimizes the battery.

Calculating Cognitive Capacity from Test Battery Results

Use of the T-Matrix allows a user to select a set of cognitive performance tests that are optimized for a particular system and job. This is a significant improvement over the conventional approach to cognitive performance testing because it incorporates quantification into the process. The next step in the process is to estimate the individual's capacity in the required cognitive skills relative to his or her “normal” capacity. Because the tests in a battery assess the skills necessary for a given job, the “normal” level of functioning on those tests approximates the way the person typically does the job. If the well-trained person typically does the job successfully, performance on the tests should reflect his or her usual cognitive “capacity” on the required skills. By implication, any decrement from that “normal” baseline constitutes an indication that the person's ability to perform the job might be impaired to some degree.

Determining the actual meaning of a decrement, however, is not a trivial task. Traditionally, one carries out a number of simple mathematical procedures such as normalization of scores and calculation of standard deviations from the person's baseline, to determine degree of decrement. However, these simply provide more numbers that, in themselves, give no clue about their practical meaning. The present inventors have recognized that there is a meaningful non-linear distribution around the person's average performance on the tests. Accordingly, a one-unit decrement from baseline does not indicate one half the amount of change in a person's capacity as a two-unit decrement. Instead, a decrement in performance of 1 standard deviation from a person's mean indicates a roughly 34% decrement in that person's capacity. Otherwise stated, a decrement in performance of 1 standard deviation from a person's mean indicates that the person is operating at about 66% of capacity. Other types of distributions might also be employed (e.g., Gaussian, Poisson, Chi-square, or individualized distributions that might skew in one direction or another). In one embodiment, the optimal distribution can be determined experimentally and then used. For the present purposes, the critical point is that a performance score on a test is translated into a metric that begins to quantitatively evaluate the person's capacity in the various cognitive skills measured by the test and needed for the job. In alternative embodiments, performance of 1 standard deviation from a person's mean indicates that a person is operating in the range of 90-100% of capacity; 80-90% of capacity; 70-80% of capacity; 60-670% of capacity; or 50-60% of capacity.

Advantageously, the above conversion of basic test scores to performance capacity measures can be done for each test in a battery. So, for each test, the person's performance relative to his or her “norm” can be multiplied by the degree that that test measures a cognitive skill (taken from the T-Matrix). This yields an array of numbers for the entire battery. This array provides a plurality of assessments of the person's capacity, one for each of the cognitive skills demanded by the job in question. For example, if a person's score on a spatial manipulation test indicates that he or she is operating at 50% capacity, and if that test demands a great deal of spatial visualization, the fact that that test “loads” heavily on spatial visualization (has a high value in the T-Matrix) demands that it should be given great weight. On the other hand, if the same test requires only a minimum amount of attention allocation, the meaning of the test score, while not zero, would be much lower. In effect, the values calculated in the array constitute a multi-dimensional assessment of the person's capacity in each of the relevant cognitive skills. By combining this multi-dimensional estimate into a single number, it is possible to arrive at an overall assessment of the person's capacity in each of the cognitive skills required by the job or mission.

It is important to note that the overall assessment is based on composite performance of the person on the entire battery, not just on a single test. Advantageously, this approach accounts for various levels of interaction among cognitive skills that occur in complex performance situations, and therefore represents a more robust way to estimate a person's cognitive capacity for a particular job than conventional techniques that are based on the results of a single test. Additionally, the establishment of a single measure of capacity in each cognitive skill lays the foundation for determining how the level of cognitive capacity affects actual performance of the job or operation of a system.

Assessment of the Mission Impact of Cognitive Capacity

While objective determination of cognitive capacity is a necessary step in assessing whether the human can operate a system or successfully perform a job, it only provides a portion of the necessary input for making such an assessment. What is also needed is more detailed data on the criticality of each cognitive demand of the system or job. “Criticality” here is operationally defined as the degree to which the mission would be compromised if the operator were not functioning at his or her normal level of cognitive proficiency.

For example, if the operator was cognitively degraded to any extent, how likely is it that the mission would fail, or the system would not operate? As an example, two cognitive skills might be required for successful performance. In this example, the first cognitive skill is absolutely critical to success in the sense that if it were not carried out successfully, a catastrophic result would ensue. The second cognitive skill, however, while also necessary, would have only minimal impact on success if it was not performed successfully. There might be ‘workarounds’ for problems related to failure or partial failure regarding the second cognitive skill, or such failure or partial failure might only degrade the degree of overall success in the mission. In the case of the first cognitive skill, if the person's capacity was minimally degraded, the result might be total mission failure. In the case of the second cognitive skill, the person might be significantly impaired, and the mission would still succeed, although perhaps at some lower level.

To generate the desired data on the criticality of each cognitive demand of the system or job, individuals intimately familiar with the system or job, at least with its design, determine how “important” it is that an operator be functioning at his or her normal capacity. In certain embodiments this can involve input from SMEs. Whether SMEs are consulted or not, the result is a ranking of the impact to the total mission if a particular task is not performed up to normal standards. The result of these rankings is a “criticality” dimension that is added to the task demands to provide a set of “criticality” ratings that are used to make the measured capacity of the person unique to the demands of the specific mission.

In one embodiment, the criticality ratings are integrated with the person's cognitive capacity for each cognitive skill involved to determine an overall assessment picture of the individual's current capacity to carry out the mission. This assessment can be presented in a number of ways—as a probability of mission success, as a graphic display of the individual's present capacity to carry out the mission, or as an assessment of the limiting or boundary conditions in which a system could be operated successfully. In any case, the final output of these analyses yields a measure of the overall capacity of the person to carry out the mission.

Discussion and Application

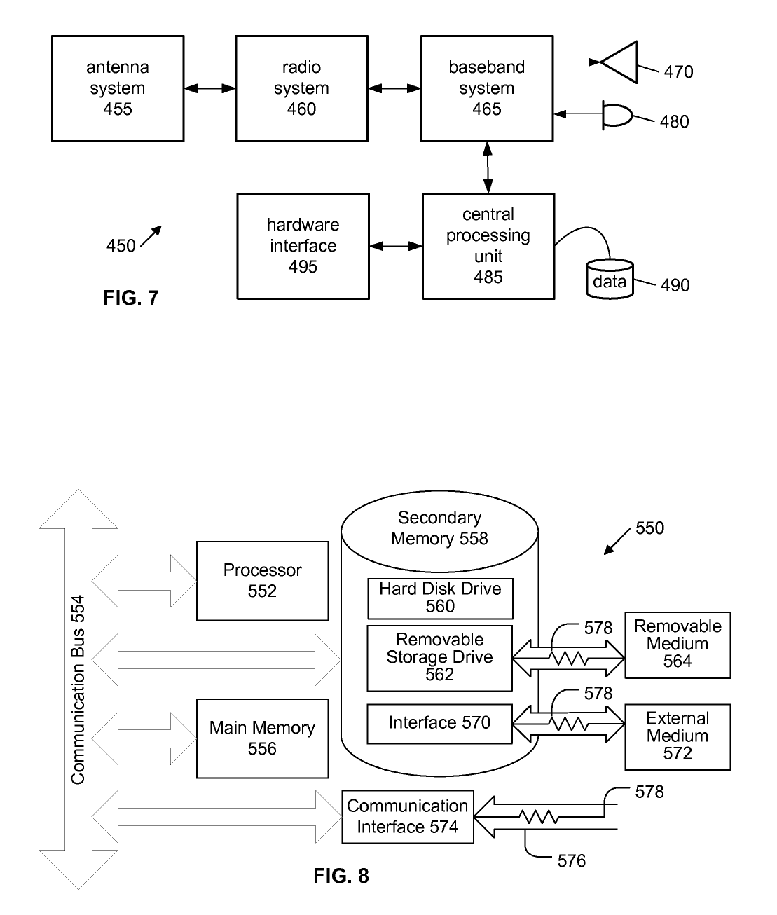

The process described above constitutes a new way of assessing what has been called a person's “readiness for duty” and represents a unique system to integrate separate assessments of the person, the system, and the mission into a composite assessment of the cognitive performance demands. This microscopic analysis of the total performance environment advantageously provides a rich set of data upon which operational decisions of system assessments can be based. Additionally, customizing a test battery for every set of job demands can be advantageously carried out by a processor executing software modules on a computer or portable wireless device such as those described below with respect to FIGS. 6 and 7. However, even when the battery is selected and configured automatically, developing a test battery for a particular job requires considerable attention to detail. Initially, the cognitive demands of the job are defined. This can be accomplished using task analyses or SME inputs, for example. Advantageously, the definitions of cognitive demands incorporate data regarding levels of criticality in the various cognitive demands.

It is worthwhile to explore areas of potential application for the systems and methods described here. Specifically, in the test and evaluation area, the need pointed out earlier to consider the capacity of the human to adapt to unusual system demands in unique ways can be addressed with this technology. In one embodiment this can be accomplished by adjusting the “criticality” ratings used in the calculations. For instance if the “problem solving” skill is considered only minimally important (i.e., has a criticality rating of “2” or “3”) that rating might be increased to “9” in the face of unexpected system problems. Each of the other required cognitive skills could similarly be adjusted based on various hypothesized system problems. By manipulating these values within the system, it is possible to define the minimum set and level of cognitive capacities required of the operator under any foreseeable degree of system malfunction. Advantageously, this permits evaluation of the system to factor in the adaptability of the human to the system and the mission.

FIG. 6A is a network diagram illustrating an example system 100 for cognitive assessment according to an embodiment of the present invention. In the illustrated embodiment, a cognitive assessment server 20 is communicatively coupled with a testing device 40 via a network 60. The server 20 can be any sort of computing device with one or more processors for executing instructions and at least one memory 25 for storing instructions, data and other information. Similarly, the testing device 40 can be any sort of computing device with one or more processors for executing instructions and at least one memory 45 for storing instructions, data and other information. The server 20 and the testing device 40 can be coupled to the network via a wired or wireless connection. Although not shown, the server 20 and testing device 40 can be communicatively linked directly to each other as well. The server 20 and the testing device 40 can be close in physical proximity or widely separated geographically. The server 20 and the testing device 40 may, in certain embodiments, be implemented using hardware devices such as those described later in FIGS. 7 and 8.

In operation, the testing device 40 is employed to interact with the subject being assessed and generates testing result data based on the interaction. This testing result data may be stored locally in its data storage area 45 or transmitted to the server 20 via the network 60 or direct communication link (not shown), or both. The testing result data is then used to generate a cognitive capacity assessment for the subject and that may be carried out at the server 20 or at the testing device 40 or using a combination of the processors at both the server 20 and the testing device 40. In one embodiment, the server 20 and the testing device 40 may be integrated into a single physical device.

FIG. 6B is a block diagram illustrating an example cognitive assessment server according to an embodiment of the present invention. In the illustrated embodiment, the server 20 comprises a test battery module 200, a T-Matrix module 300 and an assessment module 400. The various modules shown may be combined or further broken down into more granular modules as may be desired for efficiently carrying out the task of cognitive capacity assessment by the system 100.

The test battery module 200 operates to determine the optimal set of tests to employ for assessing the cognitive capacity of a person for a particular job. Accordingly the test battery module 200 identifies from an armory of cognitive tests, those tests that are suitable for use when assessing the cognitive capacity of a person to perform a particular job. As described above, certain tasks in the job may require certain functions that are well tested by one or more tests in the armory. The test battery module therefore identifies a job and in turn optimizes a battery of tests to be used to assess the cognitive capacity of a person who will possibly perform that particular job.

The T-Matrix module 300 operates to determine a matrix of cognitive skills and tests. As described above the resulting T-Matrix allows, e.g., the test battery module 200 to determine the optimal tests to be used for assessment of a person's cognitive capacity to carry out a particular job. Advantageously, the T-Matrix module 300 may continuously update the information in the matrix (e.g., stored in memory 45) to account for new data or other feedback. Such continuous updating improves the overall operation of the cognitive assessment system 100.

The assessment module 400 operates to analyze the data sets generated by the testing device 40 to provide a cognitive capacity assessment of the subject/person. The assessment module 400 analyzes the subject's scores on the test battery to determine any deviation of the subject from his or her normal cognitive capacity. The assessment module 400 also combines the results of an entire test battery into independent assessments of specific cognitive skills. The assessment module 400 also develops a total assessment of the subject's cognitive capacity to carry out a particular job or a particular task. The assessment module 400 also presents results to a user and/or the subject and may also identify and flag or report implications of assessed cognitive capacity on job performance. The assessment module 400 also predicts the effect of various stressors on an individual's cognitive performance capacity for specific jobs. The assessment module 400 also provides for rapid assessment of cognitive capacity for a subject under time constraints. For example, the assessment module 400 may work in cooperation with the test battery module 200 and the T-Matrix module 300 to identify a reduced battery of tests to administer to the subject given the operating time constraints in order to rapidly assess the cognitive capacity of the subject under the operating conditions.

To assess cognitive performance, the system 100 shown in FIGS. 6A and 6B operates using one or more processors to identify a particular battery of tests for a particular job and then carry out the testing of a subject in accordance with the particular battery and then analyze the results of those tests to assess the cognitive capacity of the subject for the particular task. The system 100 also develops and refines over time a baseline for each subject in order to more rapidly and more accurately assess current cognitive capacity of the subject for the particular task. Examples of the functionality of the system 100 in certain embodiments are provided below. Information used or generated by the system 100 can be obtained from or stored in local or remote memory 25 and 45.

Converting Scores on the Test Battery to Estimates of Changes from the Person's Normal Cognitive Capacity

As will be understood by those skilled in the art, a subject's scores on any test are either the same, higher, or lower than that person's “normal” score. To be useful in any diagnostic or predictive sense, those scores must be translated to metrics that indicate what they mean in terms of the person's current capacity with respect to the cognitive skills measured.

To calculate a “change” score from a person's baseline, it is necessary to derive a statistical value that represents a normalized variation from that baseline. One way this can be done is to calculate the number of standard deviations of the current score from the baseline. In one embodiment, this can be accomplished by distributing all of the scores for a subject according to a Gaussian distribution. In alternative embodiments, other techniques for distribution can be employed.

Whatever distribution is used, the system 100 calculates the percentage of the distribution that falls between the measure of central tendency (e.g., mean, median, or mode) and the person's current score. In one embodiment, the current score may be used to update the mean prior to the comparison or alternatively the current score may be excluded from the calculation of the mean. The analysis of the current score to the mean score represents the change (positive or negative) from the person's normal capacity for the measured cognitive skill.

While calculation of the deviation of a score is a common procedure for normalizing scores in testing and few if any distributions other than Gaussian are used for this type of normalization, the particular advantage recognized by the present inventors is that the area under the curve represents a quantifiable measure of the change in a person's “performance capacity” and that measurement can be analyzed in a general sense and also in a specific job sense. Additionally, the measurement can also be tracked over time. Therefore, use of the data generated by the system represents a wholly new way to assess cognitive capacity.

Combing the Results of an Entire Test Battery into Independent Assessments of Specific Cognitive Skills.

To improve the practical usefulness of the system 100, it is helpful to reduce the array of information generated in a cognitive test battery to simpler terms that can be understood and interpreted. Because each test in the battery estimates the person's current capacity in each of the specific cognitive skills of interest, a great deal of information is provided by the results of the test battery. Accordingly, the system 100 generates a single number that estimates an individual's cognitive “capacity” in each of the functions demanded by the job.

To estimate the person's capacity in a given cognitive skill, the individual's relative current score (against a personal baseline) on a test is determined as his or her capacity on each of the skills measured by that test. The degree to which each skill is probed by that test is given by the T-Matrix. Therefore, the system 100 derives an estimate of the relative contribution of each test in a battery to the overall assessment of the person's current capacity in each of the cognitive skills. Advantageously, this allows computation of a single number estimating the person's cognitive capacity in each cognitive skill based on the results of the entire test battery, rather than on a single test. The system 100 advantageously can carry out this process using simple programmed modules and the result is a set of “cognitive capacity” estimates, one for each of the cognitive skills required for the job.

Total Assessment of a Person's Cognitive Capacity to Carry Out a Task or a Job.

Once an individual's current cognitive capacity has been determined in each of the cognitive skills required by a job, the system calculates what the impact of these capacities will have on overall performance of the job. Even though each of the cognitive skills determined above may be required for successful job performance, they are typically not all equally critical to that performance. For instance, any level of decrement in some functions may be catastrophic, whereas significant decrement in others might simply determine that the job would not be done as well or as quickly as it might otherwise be done. Accordingly, the system 100 combines the person's cognitive capacities with the criticality of those capacities to job performance to assess the person's capacity to accomplish the job based on the person's current cognitive capacities. This may be done in a more present sense (i.e., for a current task to be performed) or in a more long term sense (i.e., for a long term job to be performed or to predict the person's capacity at some future point in time during a long term job).

As noted above, the system 100 determined the criticality of each of the cognitive skills required by a job when the original list of skills was determined for the job. In one embodiment, the system 100 maintains an association between the skills required for a job and the criticality of each of those skills. For example, the association may be stored in memory 25 or 45. Advantageously, the value assigned to each cognitive skill indicates what the effect on the job would be if the person's performance was degraded. This value can therefore inform the conclusion of the person's cognitive capacity assessment with respect to its effect on the mission (particularly in the case of a decrement in capacity). The system 100 thus is capable of generating a report or conclusion regarding the person's capacity to effectively accomplish the job by comparing the current level of a person's cognitive capacity against the criticality of the skills required for the job and also against certain business rules that can be recalled from a memory where they are stored. In one embodiment, the business rules provide the metrics or thresholds required to conclude that the person's current cognitive capacity qualifies or disqualifies the person to perform the job.

The system 100 mathematically combines the individual criticality of each cognitive skill and the person's cognitive capacity in that skill into a single composite number. This may be done by a linear treatment, by any of a number of non-linear approaches (e.g., squaring, power functions, pre-defined distributions, etc.) or a combination of these.

### Automation of Analysis; Presentation of Results and Interpretation of Job Implications

Advantageously, the system 100 stores in memory 25 or 45 a variety of data that is used in assessing cognitive capacity. For example, criticality ratings from SMEs, business rules from employers/managers responsible for a particular job, the various job skills and cognitive skills identified for each job, etc. This data can be stored in memory 25 or 45 of the server 20 or the testing device 40 or both. As previously described, various programmed software modules are provided in the system 100 that can be executed by a processor on the server 20 or the testing device 40 to carry out cognitive capacity assessment.

In one embodiment, the system 100 receives a request to assess the cognitive capacities of a subject for a particular job. The system 100 determines a prioritized list of tests (the test battery) for the job. This list may be further refined by the system 100 based on time constraints or other factors. In one embodiment, user input/selection can refine the prioritized list of tests in the test battery. The test battery is then configured by the system 100 and prepared for delivery to the subject, for example by communicating the test battery from the server 20 to the testing device 40. The testing device administers the test battery to the subject (e.g., through a user interface on the testing device such as a display, keyboard, mouse, speakers, microphone, etc.). Scores for the subject on the tests in the test battery are then used to generate the weighted estimates of the person's capacity in each cognitive skill demanded by the job. In one embodiment, the server 20 may send a baseline test battery to the testing device 40 along with the job test battery so that a new subject can perform tests to establish a baseline prior to performing tests to assess cognitive capacity for the particular job.

The results of the test battery for the activity or job are stored in memory 25 or 45 for future use and can also be presented to the subject or to the operator of the system 100 or to both or to just the operator, depending on the desires of the operator and subject. The results can be presented numerically or graphically or both. In one embodiment, the system 100 presents a color-coded table for each cognitive skill showing whether the person's performance falls into a “safe,” “questionable,” or “dangerous” category (as determined by comparison to business rules established by, e.g., operational commanders or management).

In an alternative embodiment, the results are presented such that all required cognitive skills are shown as spokes on a wheel. The person's performance capacity in each skill is located on the spoke as a distance from the center, and these distances are color-coded as above. The difference between these two presentations of results information is that in the first case feedback is given for each cognitive skill separately, and in the second case all cognitive skills are shown together. When showing all cognitive skills together, the presentation of the cognitive assessment results provides a powerful view of the person's current cognitive capacity to perform a particular job given a particular set of business rules.

Predicting the Effect of Stressors on an Individual's Cognitive Performance Capacity in Specific Jobs

The system 100 also operates to assess the person's current cognitive capacities to predict how those capacities might change in the future as a function of anticipated factors (e.g., workload/recovery) that might affect them. Accordingly, the system stores an estimate of a plurality of potential stressors and integrates their effect on cognitive capacity into the interpretation approach defined above. Accordingly, the person's measured performance on the tests can be used in combination with estimates regarding anticipated stressors to predict the person's capacity to perform the job at some time in the future. Advantageously, a particular stressor can be singled out for separate analysis just as specific cognitive skills are separated out and values can be determined for the effect that a particular stressor has on the person's cognitive capacity.

For example, the effects of “workload” on the person's future cognitive capacities can be assessed by the system 100 using a workload model. The results of the workload model also provide an estimate of a person's performance capacity over time under certain static or varying workloads. The workload model may also incorporate data regarding levels of cognitive, physical, and emotional workload. The system 100 similarly uses the output of the workload model to estimate a percentage change from baseline for any future period and thereby generate predictions about future performance based on expected workloads and current cognitive capacity. This may be used, for example to optimize work schedules for individuals that are in mission critical jobs.

The term “workload” in the context of the workload model and this specification means “the portion of an operator's limited capacity that is required to perform a particular task.” In conventional performance testing, workload has been treated as a dependent variable—that is, it has been understood and studied as the effect of something else on the workload imposed on the person. For example, the effect of a job, a mission, or a system on the workload of the person. However, in the context of this specification, workload is treated as an independent variable and performance is treated as the dependent variable. Accordingly, workload can be manipulated and its effect on a person's performance can be calculated and therefore predicted.

The workload model quantifies the relationship between workload and performance in an entirely new way. First, the workload model allows workload to be a multiply-determined construct. Accordingly, workload can be the result of the depletion of two or more separate resources. In a simple embodiment, workload can also be based upon a single resource. Second, the workload model estimates the rates at which the two or more separate resources are depleted over time by an activity, and calculates the effect of this depletion on the person's predicted performance. Incorporating the time dimension into workload estimation provides the workload model with unique advantages over conventional performance testing that has not previously used the time dimension.

In one embodiment, the basis of the estimated rates of depletion is the expert opinion of individuals familiar with the activity (e.g., in the case of NASA—astronauts), and also the opinion of cognitive scientists. Creation of the estimated rates of depletion involves development of mathematical functions that describe the performance decrement expected as a result of the person's workload at each point in time during the activity.

Third, the workload model combines the estimated depletions of each of the resources to calculate a single estimate of the workload of the activity. The calculation may range from simply adding the separate resources, to complex mathematical functions involving non-linear techniques.

In one embodiment the workload model uses a stressor's effect on future performance to modulate the person's future anticipated performance capacities. In this approach, the stressor's effects in the future would be expressed in terms of a percentage change in the person's general capacity, or some other metric that permits it to be used to modify estimates of the person's future specific cognitive capacities. Advantageously, the system 100 compares the estimates to the actual performance of the person either on the job or in subsequent testing. The system 100 can advantageously store predictions made for the various stressors that indicate which stressor might account for any future observed decrement (diagnostic function), and/or might indicate that the stressor's prediction curves might need to be adjusted (predictive function). Major discrepancies between predicted and actual measured capacities can also be used in a feedback loop to modify the predictive curves (adaptive function) and improve the overall operation of the system 100 over time. In this way, the effectiveness of the system 100 is expanded from a static measurement to a dynamic, diagnostic, predictive, and adaptive tool.

Additionally, the regenerative effects of sleep or rest on the person's future cognitive capacities can be assessed by the system 100 using a recovery model. For example, the recovery model separately estimates the recovery of each cognitive resource as a result of sleep or rest. In this way, the recovery model provides a complete feedback loop that allows it to run continuously over time and provide real time input to other models or modules to more accurately and comprehensively predict a person's ability to perform a job.

In one embodiment, the existing Fatigue Avoidance Scheduling Tool (FAST™) is used by the recovery model to predict the effect of sleep/work schedules on performance. The recovery model using FAST yields an estimate of a person's performance capacity as a function of particular sleep schedules. The system 100 uses the output of the recovery model using FAST to estimate a percentage change from baseline for any future period. By using the person's measured current cognitive capacities as a starting point, future predictions can be generated.

FIG. 6C is a flow diagram illustrating an example process for predicting performance according to an embodiment of the present invention. In one embodiment, the illustrated process may be implemented by the system 100 previously described with respect to FIGS. 6A and 6B. For example, the assessment module 400 may carry out the steps of FIG. 6C in one embodiment.

Initially, in step 210 the system 100 obtains estimates of the workload imposed by any particular task on the resource elements. For example, the workload may be a multi-dimensional construct that comprises three resource elements, namely: time load, mental effort, and stress load imposed by the task. This information may be obtained from a local or remote memory 25 and 45. Next, in step 215 the system 100 calculates for each resource element the performance effect values over time. Notably, establishing a function or combination of functions that determine the depletion of cognitive resources (i.e., the performance effect) over time is a non-trivial task. Advantageously the system stores historical data in memory 25 and 45 that is used to continuously optimize these functions for use on an individual by individual basis and/or on a more general basis.

Next, in step 220, the system 100 calculates the combined decrements over time for the particular task. Thus, the combined individual performance effects over time are calculated into a single composite prediction of performance over time. Next, in step 225 the system 100 calculates the combined increments over time based on the recovery rates on the workload resources provided by certain regenerative tasks (e.g., sleep, rest, etc.). The recovery rate information may be obtained by the system 100 from memory 25 or 45. Finally, in step 230, the system 100 can estimate the performance of an individual at any given future time based on the workload decrements and regenerative increments. Below, each of these steps will be discussed in further detail.

Multiple Resource Approach to Workload

In the workload model, workload is considered to be a multi-dimensional construct with behavioral or performance implications. In one embodiment, each of the “dimensions” of the workload construct is a separate “performance resource pool” that is depleted over time by the given load on that dimension in accordance with some function. The workload model advantageously allows each “dimension” (also referred to herein as a “resource”) to be diminished independently as a result of the person experiencing a given level of workload over a period of time. Mathematically, this is modeled by a quantified reduction in a resource. The reduction may be from an initial capacity of 100% or from some other initial capacity, for example when a person changes tasks in the middle of a mission or job shift.

The recovery model, by contrast, allows each “dimension” to be replenished independently as a result of the person experiencing a given level of rest or sleep over a period of time. The recovery may be from an initial capacity of 0% or from some other initial capacity, for example when a person changes tasks in the middle of a job or task.

The workload and recovery models are not dependent on a particular definition of the various resources. The models can accommodate any of the several theoretical orientations that have been proposed. For ease of explanation, the Subjective Workload Assessment Technique (“SWAT”) will be used in this description as an example. It must be remembered, however, that the various models may employ alternative techniques for depletion and replenishment such as SWAT and FAST. Other techniques may also be used as will be understood by those skilled in the art. Accordingly, with appropriate adjustments that will be apparent to those skilled in the art, any approach to workload and recovery measurement can be incorporated into the models.

Turning back to the workload model, SWAT postulates that workload is a multi-dimensional construct that comprises three types of workload—time load, mental load, and psychological stress load. Each of these is then divided into three “levels” of workload.

Estimating Depletion Rates for Each Resource and the Performance Effects

In the first step for constructing and applying the workload model, the system 100 obtains estimates of the workload imposed by any task on the resource elements. In the present SWAT example SMEs familiar with the tasks provide an estimate of the time load, mental load, and stress load of the task. The amount of time required for a given task will also depend on the SMEs estimate of the workload for each definable segment of the activity. These values are stored in memory 25 or 45 and obtained by the system 100. As previously described, establishing a function or functions that determine the resource depletion rate imposed over time by a particular task is a formidable undertaking. One reason for this is that the existing literature on workload involves a diverse set of approaches and experimental designs, including different definitions of the construct. Advantageously, as the system 100 operates, it stores historical data in memory 25 or 45 that can be used over time as input to optimize these functions. Accordingly, the system 100 may determine optimized depletion functions on an individual by individual basis and the system 100 may also determine optimized functions across a wide array of persons that provide a more generally applicable function that can be used for the initial estimates for individual persons that have not previously been analyzed by the system 100 (and, for example, did not undergo baseline testing) and thereby have no historical data or optimized functions stored in memory 25 or 45.

Combing Separate Resource Estimates into a Total Workload/Performance Curve

The workload model advantageously aggregates the performance effects of depletion of the separate resources into a single composite prediction of performance over time. In other words, the workload model determines a single value at each moment in time that reflects the performance effect of the total workload history of the individual. For example, if a task had high mental load and low stress load, the “mental resource” would deplete rapidly, and the “stress resource” would deplete slowly. The combined decrements at each point over the duration of a task would provide a first quantification of the task's total workload effect. Emphasis on the historical sequence of workload effect is critical.

Advantageously, the algorithms that are used to combine the separate resource estimates into a total workload/performance curve can be optimized by empirical data stored over time in memory 25 and 45 and further optimized by separate empirical investigations. As will be understood by those skilled in the art, these algorithms are likely to be extremely complex. In one embodiment, however, a simple additive model can be used:

Combined Decrement=decrement (time)+decrement (mental)+decrement (stress)

The major advantage of approaching workload in the above way is that it is a time-based estimate. The rates at which the different resources are depleted provide the potential for a moment-to-moment estimate of what might be called the workload/performance relationship, since workload is now considered to be the independent variable and performance the dependent variable.

Calculating Recovery Rates for the Workload Resources

Just as resources are depleted during the performance of work, resources can also be regenerated. For example, sleep is a major source of such regeneration. Rest is another source of such regeneration. In one embodiment, the system 100 (e.g., the assessment module 400) employs a recovery model to estimate the rate of recovery during sleep or rest. The workload model and the recovery module are therefore integrated by the system 100 so that the separate resources are depleted by workload at the appropriate rates as determined by the workload model and replenished by recovery (e.g., sleep or rest) at the appropriate rates as determined by the recovery model. Advantageously, the recovery model allows the system 100 to determine the capacity of each of the workload resources at the start of a new day or at the end of a break or lunch period during which recovery took place. Additionally, the recovery model allows the system 100 to determine how much an unused workload resource has regenerated during performance of a task that did not deplete that particular resource. This may be particularly advantageous at the start of a new day, the start of a new job or the start of a new task in the job for determining the capacity of each of the resources that are required for the new job or task.

Because the assessment module 400 provides both a workload model and a recovery model, the system 100 embodies a feedback loop in which daily work, stressors, rest and sleep activities are integrated into time-based continuum. Accordingly, the system 100 allows measured performance capacities to be modulated over time by a person's activities to yield a composite estimate of readiness for duty or capacity to perform any job or task (e.g., astronaut EVA or landing, airline pilot takeoff, surgical procedure, etc.).

Rapid Assessment of Cognitive Skill

Turning back to FIGS. 6A and 6B, it is recognized that assessment of cognitive skill in many real-world situations does not permit administration of many tests. Time constraints, subject motivation, and other operational considerations frequently dictate that a full test battery simply cannot be given. Advantageously, the system 100 uses the T-Matrix technique to select tests for a battery and this permits determination of the degree to which each test in a battery contributes to the final assessment number. The system 100 can therefore analyze the values to determine the relative “power” or significance of each test for predicting job readiness. Using the relative significance of each test, the system 100 can calculate the value added to the overall assessment by the addition or deletion of a single test relative to administering the entire armory or the entire test battery for the specific job. The system 100 can therefore determine the minimum number of tests to optimally assess the cognitive capacity of the subject as well as the minimum number of tests to minimally assess the cognitive capacity of the subject given the time constraints. In one embodiment, the system 100 stores in memory 25 or 45 a time factor for each test in the armory so the system 100 can determine how long any given set of tests in a test battery are likely to take to administer to the subject. Advantageously, when optimizing test batteries or minimizing test batteries, the system 100 can identify one or more tests that clearly probe most of the critical required cognitive skills for a particular job, while also identifying and prioritizing other tests that contribute relatively decreasing value to the overall assessment. Additionally, the system 100 can also determine the degree of information lost by eliminating one or more tests.

FIG. 7 is a block diagram illustrating an example wireless communication device 450 that may be used in connection with various embodiments described herein. For example, the wireless communication device 450 may be used in conjunction with a server computer that analyzes data sets to assess cognitive capacity. For example, certain tests may be administered to a subject using a wireless communication device and the results may be processed directly by the wireless device to assess cognitive capacity or the results may be provided to a server computer for processing in combination with other results or other data. As will be understood, other wireless communication devices and/or architectures may also be used, which will be clear to those skilled in the art.

In the illustrated embodiment, wireless communication device 450 comprises an antenna system 455, a radio system 460, a baseband system 465, a speaker 470, a microphone 480, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown).

In this description, the term “computer readable medium” is used to refer to any media used to provide executable instructions (e.g., software and computer programs) to the wireless communication device 450 for execution by the central processing unit 485. Examples of these media include the data storage area 490, microphone 480 (via the baseband system 465), antenna system 455 (also via the baseband system 465), and hardware interface 495. These computer readable mediums are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

FIG. 8 is a block diagram illustrating an example computer system 550 that may be used in connection with various embodiments described herein. For example, the computer system 550 may be used in conjunction with assessing the cognitive capacity of a person to perform a particular job. Other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system for assessing cognitive capacity of a human subject, the system comprising:
a non-transitory computer readable medium for storing computer executable programmed modules;
a processor communicatively coupled with the non-transitory computer readable medium for executing programmed modules stored therein;
a plurality of cognitive tests stored in the storage medium;
a test battery module stored in the non-transitory computer readable medium and executable by the processor, wherein the test battery module operates to select a subset of cognitive tests to be used to assess the cognitive capacity of a human subject for an identified job having an identified set of required cognitive skills;
an assessment module stored in the non-transitory computer readable medium and executable by the processor, wherein the assessment module operates to:
receive test results generated by an administration of at least a portion of said plurality of cognitive tests to the subject;
analyze the test results in accordance with a two dimensional T-Matrix comprising cognitive tests in a first dimension and cognitive skills in a second dimension and including weighted values of the cognitive skills probed by the cognitive tests;
calculate a cognitive assessment value for each of the plurality of cognitive skills required to carry out the job in accordance with the analysis of the test results and the T-Matrix weighted values; and
calculate the cognitive capacity of the subject to perform the job based on the cognitive assessment values for each of the plurality of cognitive skills required to carry out the job.

2. The system of claim 1, wherein the assessment module uses data generated by one or more predictive modules to forecast the cognitive capacity of the human subject over time.

3. The system of claim 2, wherein one of said predictive modules measures decrease in cognitive capacity based on workload of the subject.

4. The system of claim 3, wherein workload of the subject comprises a plurality of cognitive skills.

5. The system of claim 2, wherein one of said predictive modules measures increase in cognitive capacity based on recovery of the subject.

6. The system of claim 4, wherein recovery comprises sleep.

7. The system of claim 4, wherein recovery comprises rest.

8. A system comprising at least one processor communicatively coupled with at least one non-transitory computer readable medium, wherein the processor is programmed to assess cognitive capacity of a human subject by:
identifying a job;
identifying a plurality of cognitive skills required to carry out the job;
determining a set of cognitive tests from a plurality of cognitive tests stored in the at least one non-transitory computer readable medium that test the plurality of cognitive skills required to carry out the job;
receiving test results generated by an administration of said set of cognitive tests to the subject carried out by the processor;
obtaining a two dimensional T-Matrix from the at least one non-transitory computer readable medium comprising cognitive tests in a first dimension and cognitive skills in a second dimension and including weighted values of the cognitive skills probed by the cognitive tests;
analyzing the test results in accordance with the T-Matrix values for the cognitive skills tested by the set of cognitive tests;
calculating a cognitive assessment value for each of the plurality of cognitive skills required to carry out the job in accordance with the analysis of the test results and the T-Matrix weighted values; and
calculating the cognitive capacity of the subject to perform the job based on the cognitive assessment values for each of the plurality of cognitive skills required to carry out the job.

9. The system of claim 8 further comprising optimizing the set of cognitive skills tests by determining a minimum number of tests to cover the plurality of cognitive skills required to carry out the job.

10. The system of claim 8 further comprising optimizing the set of cognitive skills tests by determining a set of cognitive skills tests that takes the least amount of time to administer.

11. The system of claim 8 further comprising obtaining data generated by one or more predictive modules and forecasting the cognitive capacity of the human subject over time in accordance with the assessed cognitive capacity and the predictive module data.

12. The system of claim 11, wherein one of said predictive modules measures decrease in cognitive capacity based on workload of the subject.

13. The system of claim 12, wherein workload of the subject comprises a plurality of cognitive skills.

14. The system of claim 11, wherein one of said predictive modules measures increase in cognitive capacity based on recovery of the subject.

15. The system of claim 14, wherein recovery comprises sleep.

16. The system of claim 14, wherein recovery comprises rest.

17. A computer implemented method for assessing cognitive capacity of a human subject, comprising:
using a processor to:
identify a job;
identify a plurality of cognitive skills required to carry out the job;
determine a set of cognitive tests from a plurality of cognitive tests that test the plurality of cognitive skills required to carry out the job;
receive test results generated by an administration of said set of cognitive tests to a human subject;
obtain a two dimensional T-Matrix from memory comprising cognitive tests in a first dimension and cognitive skills in a second dimension and including weighted values of the cognitive skills probed by the cognitive tests;
analyze the test results in accordance with the T-Matrix values for the cognitive skills tested by the set of cognitive tests;
calculate a cognitive assessment value for each of the plurality of cognitive skills required to carry out the job in accordance with the analysis of the test results and the T-Matrix weighted values; and
calculate the cognitive capacity of the subject to perform the job based on the cognitive assessment values for each of the plurality of cognitive skills required to carry out the job.

18. The method of claim 17 further comprising optimizing the set of cognitive skills tests by determining a minimum number of tests to cover the plurality of cognitive skills required to carry out the job.

19. The method of claim 17 further comprising optimizing the set of cognitive skills tests by determining a set of cognitive skills tests that takes the least amount of time to administer.

20. The system of claim 17 further comprising obtaining data generated by one or more predictive modules and forecasting the cognitive capacity of the human subject over time in accordance with the assessed cognitive capacity and the predictive module data.

21. The system of claim 20, wherein one of said predictive modules measures decrease in cognitive capacity based on workload of the subject.

22. The system of claim 21, wherein workload of the subject comprises a plurality of cognitive skills.

23. The system of claim 20, wherein one of said predictive modules measures increase in cognitive capacity based on recovery of the subject.

24. The system of claim 23, wherein recovery comprises sleep.

25. The system of claim 23, wherein recovery comprises rest.

26. A non-transitory computer readable medium having stored thereon one or more sequences of instructions for causing one or more processors to perform the steps for assessing cognitive capacity of a human subject, the steps comprising:
identifying a job;
identifying a plurality of cognitive skills required to carry out the job;
determining a set of cognitive tests from a plurality of cognitive tests that test the plurality of cognitive skills required to carry out the job;
receiving test results generated by an administration of said set of cognitive tests to the subject;
obtaining a two dimensional T-Matrix comprising cognitive tests in a first dimension and cognitive skills in a second dimension and including weighted values of the cognitive skills probed by the cognitive tests;
analyzing the test results in accordance with the T-Matrix values for the cognitive skills tested by the set of cognitive tests;
calculating a cognitive assessment value for each of the plurality of cognitive skills required to carry out the job in accordance with the analysis of the test results and the T-Matrix weighted values; and
calculating the cognitive capacity of the subject to perform the job based on the cognitive assessment values for each of the plurality of cognitive skills required to carry out the job.
